(19) United States
(12) Patent Application Publication
(10) Pub. No.: US 2010/0005385 A1
(43) Pub. Date: Jan. 7, 2010

(54) SYSTEMS AND METHODS FOR MAINTAINING A PLURALITY OF COMMON INTEREST COMMUNITY WEB SITES

(75) Inventors: Jeff TRABUCCO, Bainbridge Island, WA (US); Chris Barrett, Purvis, MS (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: ARTS COUNCIL SILICON VALLEY

(21) Appl. No.: 12/560,379

(22) Filed: Sep. 15, 2009

Related U.S. Application Data
(63) Continuation-in-part of application No. 10/861,102, filed on Jun. 4, 2004.

(51) Int. Cl. G06F 3/14

(52) U.S. Cl. 715/234

(57) ABSTRACT

Systems and methods described herein may facilitate scalability while permitting quick deployment and customization of web sites. In some embodiments, customization may involve associating custom software modules, content, and pre-compiled content templates with web-sites that are being served by a web-server application using a database. Systems and methods disclosed facilitate software maintenance, scalability, content sharing, and customization using the custom software modules and templates associated with the web-sites to serve content associated with the web site to users.

### RELATED APPLICATIONS

This application is a continuation-in-part of application Ser. No. 10/861,102 filed on Jun. 4, 2004 entitled “Creation and Management of Common Interest Community Web Sites,” which is hereby incorporated by reference into this application for all purposes.

### BACKGROUND

1. Field of the Invention

The present disclosure is directed to the field of computer software and in particular to software for the rapid creation and deployment of web sites for common interest communities.

2. Description of Related Art

Development of modern, sophisticated web sites is costly and time-consuming. Web server software that powers such web sites may be composed of hundreds of software source files, comprising many thousands of lines of software code. Web server software often incorporates software modules that were developed in-house or were purchased from third-parties to perform various functions. Use of such modules may decrease the cost and time to develop the web server software suite.

As web sites increase in sophistication, the quantity of information they process coupled with the continuously increasing functionality that users expect sites to provide have led to the incorporation of an ever increasing number of functional extensions. Typically, instead of wholesale replacement of existing web server software, these functional extensions are incorporated into existing websites by adding additional software modules. Thus, over time, web-sites accumulate a motley collection of software modules that are tied together without a coherent architectural framework, thereby severely impacting maintainability, operability, reliability, and performance.

Moreover, operators of such web sites are often prevented from realizing economies of scale by deploying an existing web server with its attendant software modules to maintain related web sites because of the complexities associated with customization. Additionally, maintaining each web site with a dedicated custom server solution may be prohibitively expensive because of the time and expense associated with maintenance of the numerous software modules, each of which may face security upgrades, bug fixes, or functional upgrades at different times. Finally, the cost of creating and storing archival back-ups of each system can become substantial when a large number of such servers are deployed. Accordingly, there is a need for a quickly deployable and customizable solution for site operators that facilitates scalability while reducing operational and maintenance costs.

### SUMMARY

In some embodiments, a computer-implemented method for customizably configuring the operation of a plurality of common interest community web sites using a common software platform, wherein the software platform comprises a plurality of custom functional modules, which allow customization of the web sites, method comprises: associating at least one of the plurality of web-sites with at least one of the plurality of custom functional modules, associating the at least one web site with a portion of the content in a database; associating the at least one web site with at least one pre-compiled web page template, wherein the pre-compiled web page template determines, at least in part, the organization and layout of content of the associated web-site; storing the association between the web-site and the at least one custom functional module, the association between the web-site and the content, and the association between the web-site and the at least one pre-compiled web page template in the database; and invoking at least one web server for the at least one web site, wherein the web-server invokes the at least one custom functional module associated with the web-site and wherein, in response to a request, the web server composes a web page using the pre-compiled web page template.

Embodiments disclosed may also be implemented using program code on computer-readable media and/or code in computer readable memory.

### BRIEF DESCRIPTION OF THE DRAWINGS

FIG. 1 illustrates a conventional system that allows two users to access web pages on two servers over the Internet.

FIG. 2A illustrates an exemplary system that responds to web page requests directed to a plurality of web sites.

FIG. 2B shows an exemplary embodiment including details of the software components.

FIG. 2C illustrates an exemplary database table indexed using a database identifier and/or a site key.

FIG. 2D illustrates an exemplary database table, which uses a database identifier and/or a site key, as part of the table name.

FIG. 3 shows a flowchart illustrating an exemplary method for creating a web site.

FIG. 4 shows a flowchart illustrating an exemplary method for creating or editing a new web page template for a web site.

FIG. 5A shows a flowchart illustrating an exemplary method that may be used by a web server to customize site configurations.

FIG. 5B shows a flowchart illustrating another exemplary method that may be used by a web server to customize site configurations.

FIG. 6 shows a flowchart illustrating an exemplary method for responding to URL requests directed to a web server.

### DETAILED DESCRIPTION

Systems and methods described herein facilitate scalability while permitting quick deployment and customization of web sites. Methods disclosed also permit improved performance of systems and software for web site deployment and operation.

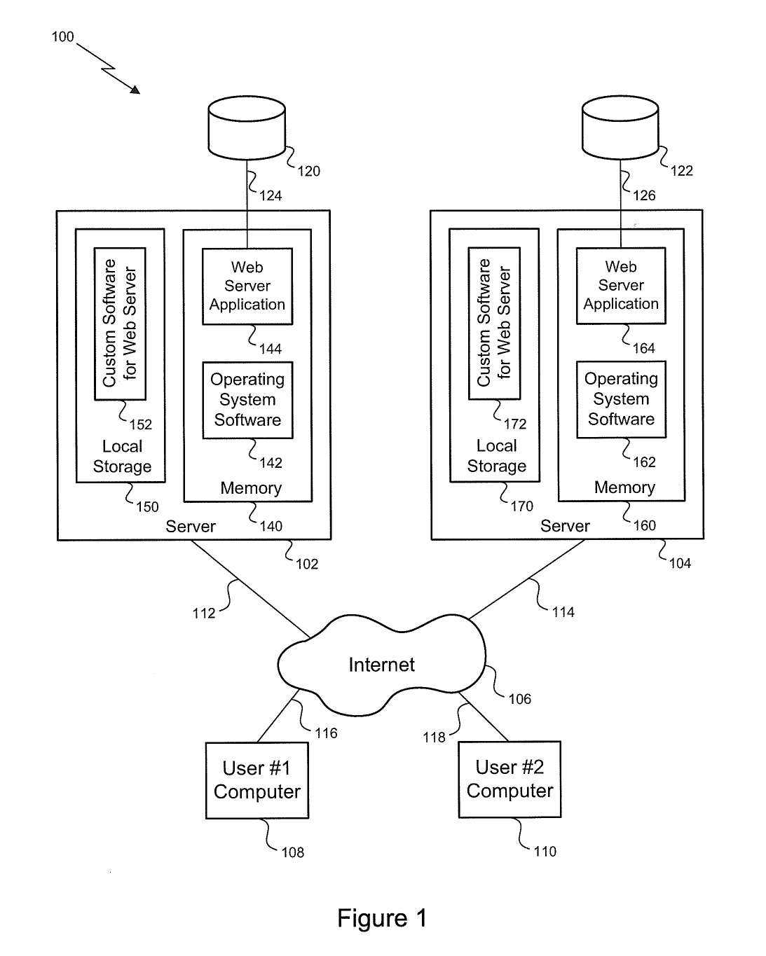

FIG. 1 illustrates conventional exemplary system 100 that allows two users to communicate with two web servers through the Internet. System 100 includes first user's computer 108 and second user's computer 110, coupled to Internet 106 through network connections 116 and 118, respectively. System 100 also includes first server 102 and second server 104, coupled to Internet 106 through network connections 112 and 114, respectively. For example, first server 102 may maintain a first web site dedicated to a first community of common interest, while second server 104 may maintain a second web site dedicated to a second community of common interest. The first and second web-sites may be related and share some portion of the available content that is displayed users who browse the sites.

First server 102 may be a computing device with computer memory 140 and local storage 150. Memory 140 may be random access memory (“RAM”) and local storage 150 may include hard disks, removable media such as CD ROM/RW drives, DVD ROM/RW drives, flash drives and memory card readers. Memory 140 may contain executable software programs, including operating system 142 and first web server application 144. Local storage 150 may store one or more custom software modules 152 that are loaded into memory 140 and executed in conjunction with first web server application 144. First web server application 144 may communicate with first database 120 through interface 124, which may include a combination of hardware and software. First database 120 may store information including content for the first website. For example, the database may include the names and account information for users of the first website, information relating to events displayed on the calendar of the first website, or any other data related to the first web site. Other traditional elements of a computing device, such as a microprocessor, and Input/Output (“I/O”) controller, and a network interface card (“NIC”) have been omitted from FIG. 1 for ease of description.

Similarly, second server 104 may be a computing device with computer memory 160 and local storage 170. Memory 160 can include executable software programs, including operating system 162 and second web server application 164. Local storage 170 may store one or more custom software modules 172 that can be loaded into memory 160 and executed in conjunction with second web server application 164. Second web server application 164 may communicate with second database 122 through interface 126, which may include a combination of hardware and software. Second database 122 may store information including content for the second web site. Databases 120 and 122 may be relational databases and may contain a plurality of database tables. Content in databases 120 and 122 may overlap.

A first user at computer 108 may learn of events or communicate with users pertaining to the first community of common interest through the first web site maintained by server 102. Similarly, second user at computer 110 may learn of events or communicate with users pertaining to the second community of common interest through the second web site maintained by second server 104.

Custom software modules 152 and 172 may be provided for operating the first and second sites, respectively. In conventional systems, such as system 100, web server applications 144 and 164 may interact with custom software modules 152 and 172, respectively, which can provide customization for each of the sites. Accordingly, the maintenance and operational costs of system 100 are increased manifold because of the duplication of code and the use of different software modules for the two sites, and for reasons outlined earlier.

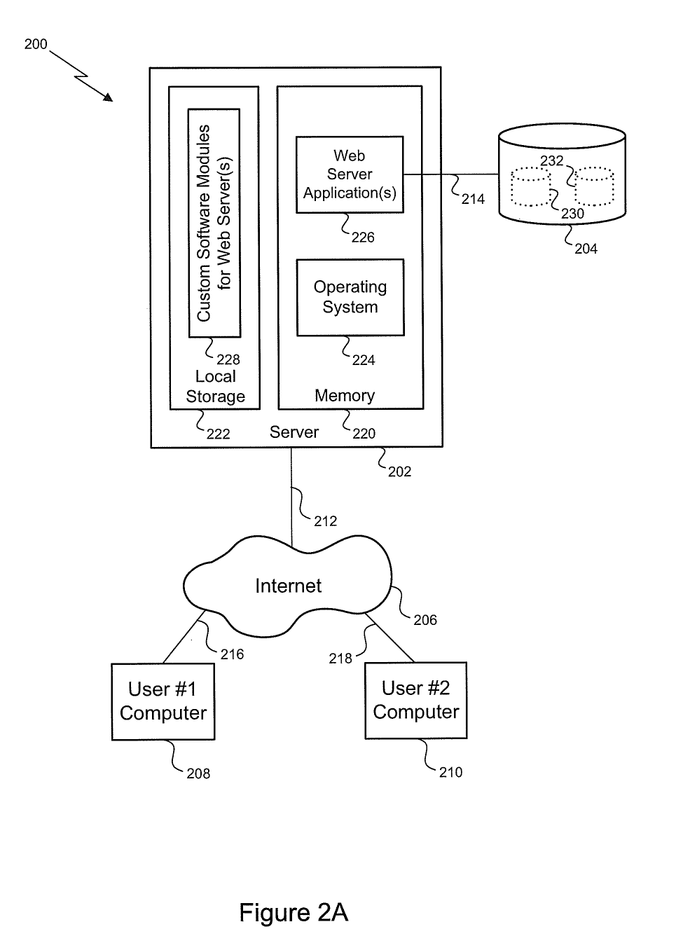

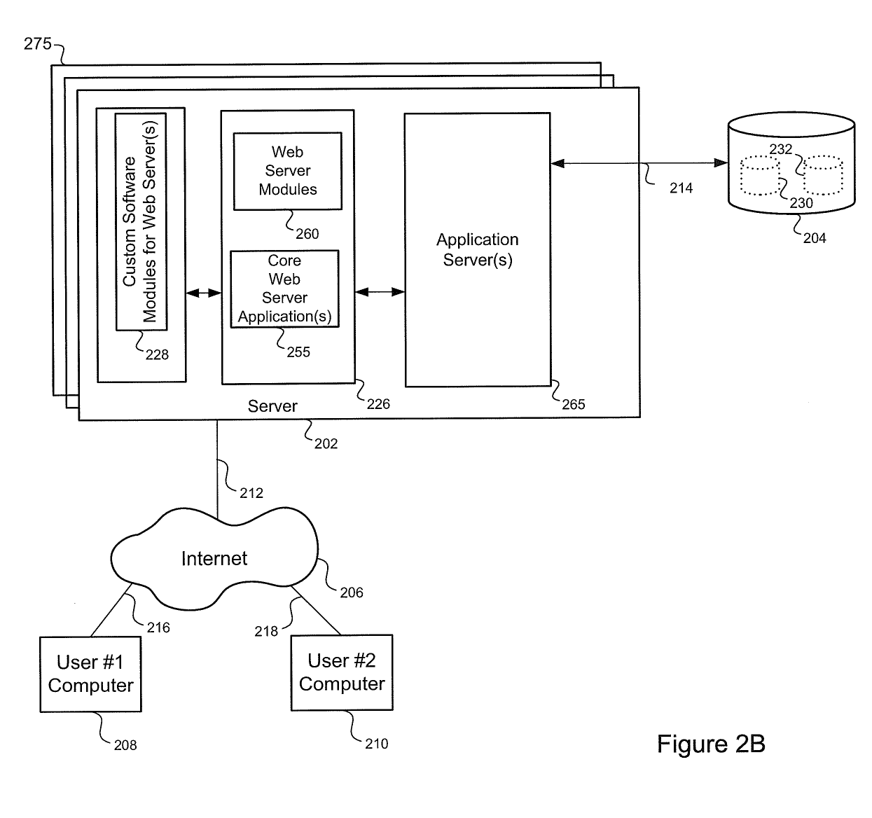

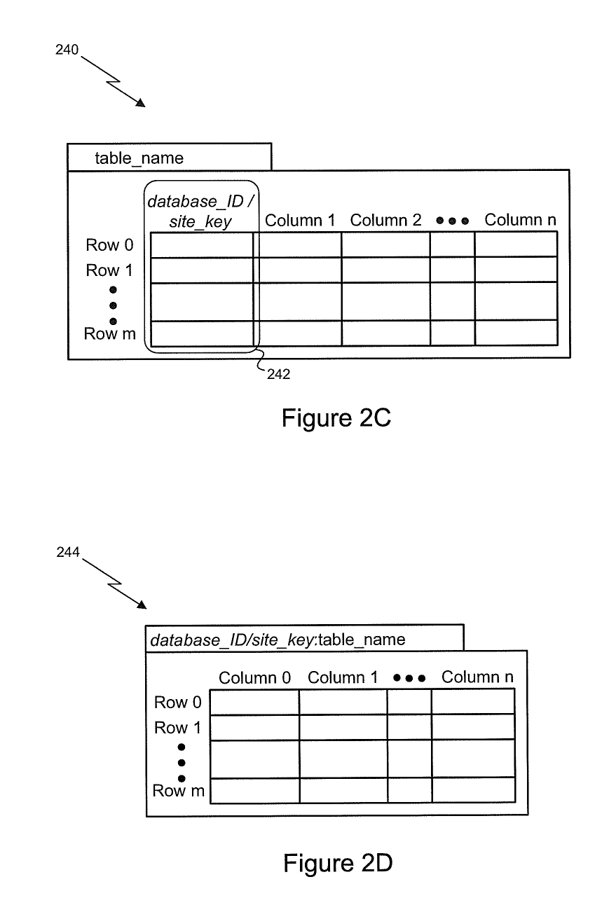

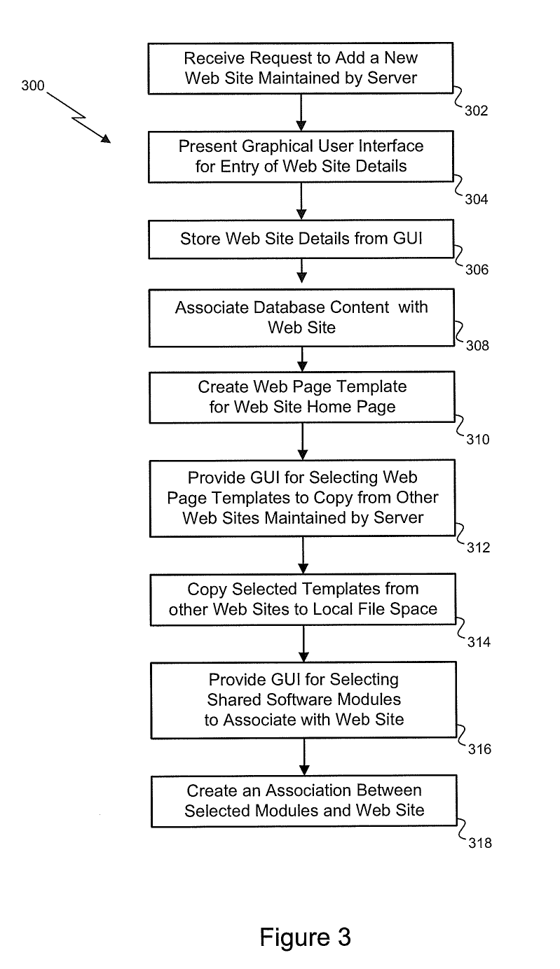

FIG. 2A illustrates an exemplary system 200 that responds to web page requests directed to a plurality of web sites. System 200 includes first user's computer 208 and second user's computer 210, which are coupled to Internet 206 through network connections 216 and 218, respectively. System 200 also includes database 204 and server 202, which is coupled to Internet 206 through network connection 212. Server 202 may be used to operate, administer, and maintain a plurality of customizable web sites, including a first web site dedicated to a first community of common interest and a second web site dedicated to a second community of common interest.

Server 202 may be a computing device with computer memory 220 and local storage 222. Memory 220 may be random access memory (“RAM”) and local storage 222 may include a hard disk, removable media such as a CD ROM/RW drive, DVD ROM/RW drive, flash drives and memory card readers. In addition, server 202 may also include other software and hardware components such as an application server, application software, a microprocessor, an Input/Output (“I/O”) controller, and a network interface card (“NIC”), Read Only Memory (ROM), various I/O interfaces etc.

In addition to operation system 224, other executable software programs may be loaded into memory 220. For example, memory 220 may include a single web server application, or a plurality of web server applications 226. In one embodiment, one web server application 226 may be present in memory 220 for each web site maintained by server 202. In some embodiments, one web server application 226 may be present in memory 220 for a plurality web sites maintained by server 202. In another embodiment, a single web server application 226 may be present in memory 220 for all web sites maintained by server 202. In some embodiments, some of the web server applications 226 may be child processes that operate under the control of a master web server application 226. In some embodiments, the web server applications 226 may represent several instances of the web server application 226.

Local storage 222 may store one or more custom software modules 228 that can be invoked by web server application 226, and then loaded into memory 220 before being executed. Web server application 226 may communicate with database 204 through interface 224, which may include a combination of hardware and software.

In some embodiments, database 204 may include content for the plurality of web-sites running on server 202. In some embodiments, information for the plurality of sites may overlap. In one embodiment, database 204 may contain fields that indicate the correspondence between content and sites. Accordingly, an Application Programming Interface (“API”) to application server(s) or other software may be used to run queries that retrieve content for a specific web-site running on server 202. In some embodiments, database 204 may also include information that correlates functional modules stored on server 202 with web-sites. Accordingly, the API may be used by web server application(s) 226 to query database 204 to provide the names of functional modules that are used to customize a specific web-site. Accordingly, the information contained in database 204 may be viewed logically as equivalent to a plurality of databases. For example, FIG. 2A shows that database 204 can include information for two web sites, and can viewed logically as equivalent to two individual databases 230 and 232 for the two web-sites.

In one embodiment, database 204 may comprise a collection of tables, where each web-site may have a separate name space for the tables associated with that site. Thus, in such embodiments, table names may be common across web-sites but belong to different name spaces. Therefore, based on the separate table name spaces, a table with a particular name in one logical partition of the database may be distinct from a table with the same name in another logical partition of the database. Therefore, in some embodiments, the same code may be used to run and customize multiple sites by switching name spaces in accordance with the sites. For example, when “web-site1” is being customized, “NameSpace1,” which may correspond to “web-site1” may be used. Similarly, when “web-site2” is being customized, “NameSpace2,” which may correspond to “web-site2” may be used, and so on. Thus, such logical separation of tables may conveniently avoid name collisions among database tables within a single conventional database.

In actual implementation, the number of database tables and namespaces utilized by web server application 226 for each web site may vary and depend on implementation specific parameters. In one embodiment, database 204 may be configured to use a key that helps distinguish information by web site. For example, a “site key” may be used to correlate information with a specific web site. In one embodiment, the “site key” may correspond to a column in one or more database tables. In some embodiments, the site key may be recurring and permit multiple web-sites to be associated with the same content.

FIG. 2B shows an exemplary embodiment including details of the software components. As shown in FIG. 2B, system 275 includes web server application(s) 226 running on servers 202. In some embodiments, web server applications 226 may comprise core web server application(s) 255, which may use one of more core web server modules 260. In addition, web server application(s) 226 may co-operate and invoke one or more custom software modules 228. In some embodiments, each of custom software modules 228 may be independently configurable. In one embodiment, custom software modules could be configured to serve individual sites. In some embodiments, one or more custom software modules execute as independent processes and be used to serve one or more web sites. In some embodiments, system 275 may include several hardware servers 202 serving requests to the several web-sites. In some embodiments, one or more modules associated with core web server application(s) 226 may execute as threads in systems that support multi-threading environments.

As shown in FIG. 2B, web server application(s) 226 may also communicate with application server(s) 265, which may provide functionality to store, update, delete and manage content in database 204. As shown in FIG. 2B and described earlier, database 204 may be organized internally as a relational database, with a plurality of internal tables. In some embodiments, content in the tables may be associated with specific web sites identified by a site identifier or a site key.

FIG. 2C illustrates an exemplary database table 240 indexed using a “database_ID” and/or a “site key.” Table 240, with name tablename, may include a series of columns 1 . . . n for storing data in a record within the table, and a series of rows 0 . . . m for storing records within the table. Additionally, table 240 may include column 242 for storing identifiers for each record in the table, where each identifier can indicate a correspondence between the record and a logical partition of the database. In one embodiment, column 242 may be a database key for table 240.

In another embodiment of the present invention, database 204 may be configured to use database tables with specialized table names. These specialized table names may be formed by adding a database_ID or site key identifier to the name of each database table within the database. Thus, data for the first web site may include tables whose names include an identifier corresponding to the first logical partition of the database and/or a site key corresponding to the first site, and the data for the second web site may include tables whose names include identifiers corresponding to the second logical partition of the database and/or site key.

FIG. 2D illustrates an exemplary database table 244, which uses a “database_ID” and/or a “site key,” as part of the table name. As shown, table 244 includes rows 0 . . . m and columns 0 . . . n. In addition, as shown in FIG. 2D, the table name for database table 244 can include a database identifier. In one embodiment, the database identifier (e.g., “site1”) may appear as a prefix to a string that reflects the nature of the information in the table (e.g., “users”) to form the table name (e.g., “site1:users”). Those skilled in the art will readily recognize that any form of site identifier may be used, including alphanumeric or binary-encoded site identifiers.

Thus, the exemplary architecture described in relation to FIGS. 2A-2D may allow server(s) to respond to web page requests for a plurality of web sites and permit scalability. Because the same code may be used in some embodiments to maintain a plurality of web-sites, these embodiments may also facilitate realization of economies of scale by reducing cost to deploy, maintain, administer, customize, and upgrade systems. In one embodiment, software module sharing may be accomplished by storing associations between software modules and web sites that utilize those modules in the database. Collectively, the web server application 226 and the custom software modules 228 may form a common software platform that permits realization of the exemplary architecture described above.

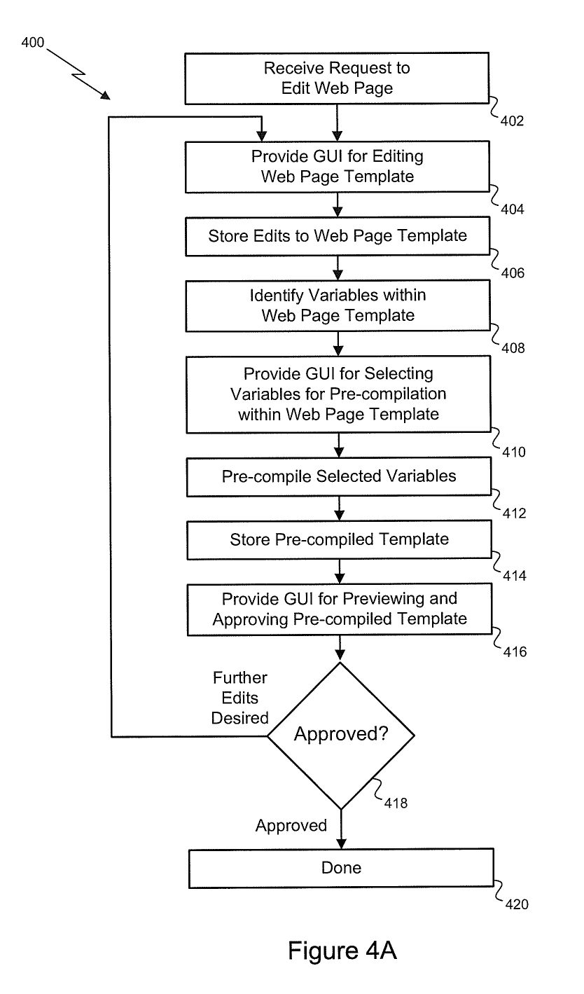

FIG. 3 shows a flowchart illustrating an exemplary method 300 for creating a web site. In one embodiment, these method steps may be performed, at least in part, by web server application 226. In other embodiments, one or more of these method steps may be performed by other software in system 200, which may be invoked by web server application 226. In some embodiments, method 300 can begin in step 302, where a request may be received to add a specified website. This request may be initiated by a system administrator through an administrative software interface to web server application 226. In step 304, a software graphical user interface (“GU I”) for entering textual information concerning the web site to be added may be presented to the person initiating the web site creation request. In one embodiment, this GUI may allow entry of the name of the web site to be added, the Uniform Resource Locator (“URL”) for the web site to be added, and a description of that web site. In other embodiments, entry of other types of information may be allowed. In step 306, the web site information entered into the GUI is stored in the database 204. In step 308, a logical partition of the database may be created by associating content in the database with the web site to be added.

In step 310, a web page template may be created for the home page of the web site to be added. In one embodiment, a web page template may include a collection of program code and raw content that may be transformed and formatted into a web page when a web page request is made. In some embodiments, the web page template may allow a custom web page to be designed quickly, by providing a format for the overall page as well as by defining the regions within a web page and allowing those regions to be customized. In some embodiments, the code within the web page template that defines a region may permit the selection of content to be displayed in the region and/or permit the invocation of additional program code that will generate content for display in the region. An exemplary web page template may define a header region; a body region, which can include sub-regions containing code to query a database for content and then display the content in the appropriate sub-region; and a footer region. For example, the header region may containing a site logo while the body region may contain code that queries a database for a series of arts events then displays the events and associated content retrieved by the query. The footer region may, for example, contain site related information, copyright notices etc.

In addition to the regions within the web page, the code in the web page template may incorporate information conventionally communicated with a web page, such as the author of the web page, the version of the HTTP protocol used to encode the web page, and references to cascading style sheets that may configure the visual and aesthetic aspects of the web site.

In step 312, a GUI may be provided to allow the requestor to select web page templates to be copied from other web sites maintained by the server 202. In one embodiment, the software may identify the web page templates present for other web sites maintained by server 202, and then list those templates by web site, in the GUI. In some embodiments, the GUI may also allow individual selection of the various web page templates, so one or more web page templates may be selected and copied in a single operation. In step 314, the web page templates selected in step 312 are copied from their respective web sites into the web site that was added in step 312.

In step 316, a GUI can be provided for the selection of shared and custom software modules used by the web site to be added. In one embodiment, this GUI may include a list of all modules that are stored on server 202 and also provide the ability to select one or more new additional modules for association with the web site to be added. Once an association is created between a module and a web site, that module may be added to code associated with web site. In one embodiment, adding a module to a web site may allow some or all of the functions within a module to be utilized by the web server and/or web page templates within the web site. However, the functions within a module utilized by one web site may differ from functions within the same module utilized by another web site.

The method for adding a web site may conclude in step 318, where associations between the software modules selected in step 316 and the web site to be added are created and stored in database 204 with appropriate indexes and/or keys to permit quick site specific retrieval.

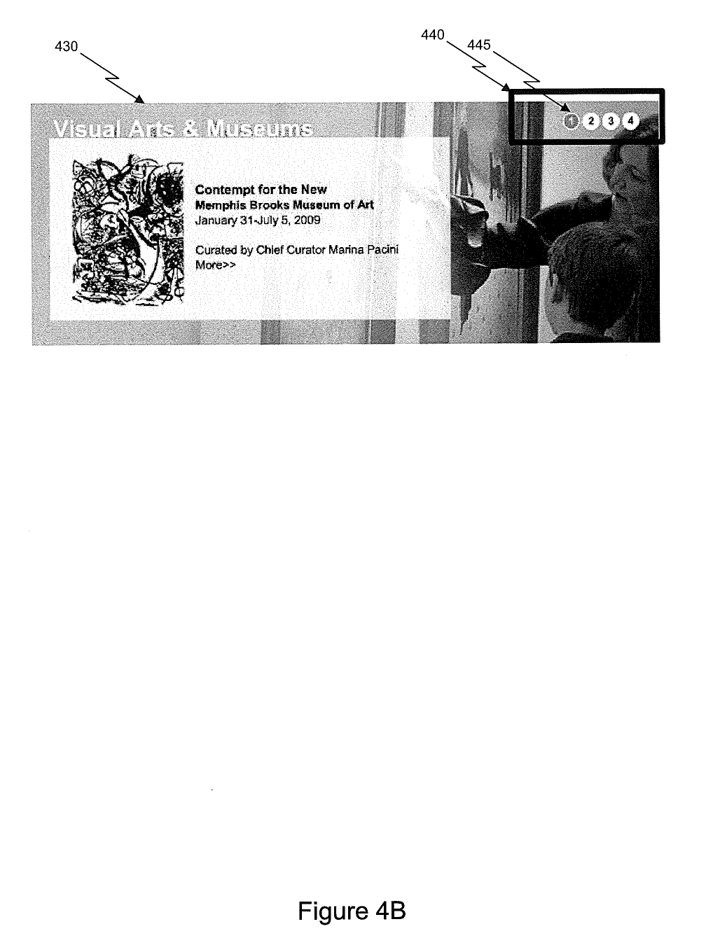

FIG. 4 shows a flowchart illustrating an exemplary method 400 for editing a web page template for a web site. In one embodiment, these method steps may be performed by administrative code associated with web server application 226. In other embodiments, one or more of these method steps may be performed by other software in system 200. Method 400 can begin with step 402, where a request to edit a web page template may be received. In one embodiment, this request may be initiated by a system administrator through an administrative software interface associated with web server application 226. In one embodiment, a web page template may contain some of the structure and content of a complete web page template but may also include areas within the template that a system administrator may associate with customized structure, logic, or content for the template.

In one embodiment, the web page template may include code that allows a first web page to be displayed as a frame and/or a sub-region within a second web page. This embodiment may allow a first web site to act as a portal for a plurality of related web sites and permit content from the related web-sites to be displayed in a sub-region or a frame associated with the web page for the first web-site or portal. For example, a web site may serve as a portal for a community of common interest and display links to related child community sites, which when activated (clicked on by a user) bring up content associated with the child site in a sub-region or frame of the site that serves as the portal for the community. In some embodiments, content for the frame or sub-region in which the child web-site is displayed may be automatically generated from portions of the template associated with the child web-site. In some embodiments, the web-server associated with the child web-site may be passed one or more flags, which may instruct the server to return content generated from a portion of the site template. For example, the child web-server may be sent a flag requesting information for content related to the body of the template associated with the child web site. The content generated by the child web-server may then be displayed in the sub-region or frame associated with the (parent) portal site.

Additionally, this embodiment may provide that clicking on a link within a web page on the portal web site, thereby selecting a web site to visit, may refer the user to a web page whose outer border is comprised of information or graphics from the first web site and whose inner frame is comprised of a web page from the selected web site. In one exemplary embodiment, a first web site could act as an arts portal for a plurality of child web sites that are each dedicated to arts in a particular city. In some embodiments, the child web sites may be navigated to independently by providing a URL associated with the child site directly in a browser running on user computers 208 or 210.

In step 404, the system administrator may be presented with the web page template for editing. In one embodiment, a GUI may allow the system administrator to edit the web page template. This GUI may provide conventional capabilities for viewing the web page template, inserting or deleting text within the web page template, and storing edits made to the web page template in database 204. The system administrator may edit the web page template to include visual elements to enhance the aesthetic appeal of the web page that is generated. Editing the web page template may also include adding logical elements such as software code to provide custom functionality to the web page that will be generated. Editing the web page template may also include adding content. In one embodiment, logical code may be added to a web page template that can query database 204 for specific events (such as spotlighted events), which may appear in a section of the template. These events or content associated with the events may be and presented in a list of spotlighted events within the section on the generated web page. In step 406, edits to the web page template may be received and stored in database 204.

In step 408, any variables within the web page template are identified. Variables, which may take the form of program code, can act as placeholders for content, which can be identified at the time that the web page is generated from a web page template. In one embodiment, variables may be distinguished from other elements of the web page template by an identifier, such as “$,” which may precede the variable and set it apart from other elements of the web page template. In an exemplary embodiment, a web page template may include a region for welcoming users that have just logged-in with the following code: “Hello $username—welcome back!.” In this embodiment, the variable “$username” may be a placeholder for the name of the user that is currently logged—in to the web site. If the name of the user is “Joe User” at the time this code is executed, in conjunction with generation of a web page from the web page template, the result may be to form the string “Hello Joe User—welcome back!” In some embodiments, the variable may invoke program code to generate the content. For example, pictures may be decompressed, scaled, and rendered and/or links may be populated using information generated by database searches. In general, variables can be used to generate content dynamically. In some instances, variables may also be able to generate some or all of template dynamically. Variable identification within a web page template may be performed by parsing the web page template. For example, the template may be parsed for a text string preceded by an indicator.

In step 410, a system administrator may be presented with a list of variables that may be pre-compiled from the web page template that was recently edited. In one embodiment, a GUI may present the system administrator with a list of variables that were identified in the web page template during step 408. In one embodiment, a check box GUI element may be associated with each variable, thereby allowing the user to indicate whether the corresponding variable should be pre-compiled. In an exemplary embodiment, a variable named “$sitename” may be present in a web page template. This variable may be incorporated into the web page template to display a welcome message to visitors, such as “Welcome to $sitename—we hope you enjoy your visit.” In this embodiment, pre-compilation of the $sitename variable may be desirable because the name of the web site is known and unchanging at time of pre-compilation. Thus, in this embodiment, server performance benefits may be realized by replacing the $sitename variable with its corresponding content during web page template pre-compilation, rather than performing this replacement in response to each web page request that displays such content. In other exemplary embodiments, pre-compilation of variables such as “$username” may not be desirable because the content associated with those variables may not be known at the time of pre-compilation. In step 412, for each variable whose pre-compilation was requested, the variable may be replaced with a value for that variable.

In some situations, the values of one or more variables may be determined by reading their values from tables associated with the web site in database 204. In these instances, the selected variables may be replaced with their corresponding values, and the result is referred to as a “pre-compiled web page template.”

In step 414, the pre-compiled web page template may be stored in database 204. An association between the pre-compiled web page template and its corresponding web page may also be stored in database 204. In step 416, the pre-compiled web page template may be rendered to the system administrator via a GUI that allows for approval of the pre-compiled web page template or a determination that further editing of the web page template is desired. Rendering a pre-compiled web page template may involve replacing any variables not previously pre-compiled with their corresponding values, determined by reading their values from tables associated with the web site in database 204, and displaying the web page that results to the user.

In step 418, an indication of whether the user approves the pre-compiled web page template or desires to edit the web page template further is received. If the user approves the pre-compiled web page template, method 400 continues to step 420, where the method 400 terminates. If the user desires to edit the web page template further, method 400 returns to step 404.

In one embodiment, the concept of pre-compilation may be advantageously applied to software code that is configured to read content from a database. FIG. 4B illustrates an exemplary multi-media element 430, which may be generated using software code that may read exemplary spotlighted events from database 204. The events are shown within box 440 in FIG. 4B and indicated by numeric identifiers 445. Each of the numbers 1, 2, 3, and 4 indicated by identifier 445 in FIG. 4 may correspond to a different event and/or content. As shown, element 430 may describe details of an event including its title, location, and date or date range. Element 430 may also include an image that relates to the event and a graphical frame for displaying the event or the details of the event. In one embodiment, software code may be written to generate the graphical frame for the event, read content corresponding to the event from database 204, and combine the frame with its content to create element 430 as shown. In some embodiments, some sections of the template, such as the element 430, which may be a spotlight box, can be common to the common-interest community portal and to the plurality of web-sites associated with the portal thereby permitting the same content to be shown across several web-sites.

Pre-compiling the software code that produces element 430 may reduce the number of database queries involved in generating element 430 at the time of web page request, relative to conventional techniques. This reduction of database queries may be accomplished by pre-compiling this software code to replace variables, corresponding to content stored in a database, with the values of such variables. Since execution of database queries may tend to reduce web server performance, reduction of database queries through pre-compilation may bring performance benefits. In one embodiment, pre-compiled software may take the form of server-side software such as PHP. In another embodiment, pre-compiled software may take the form of client-side software such as JavaScript.

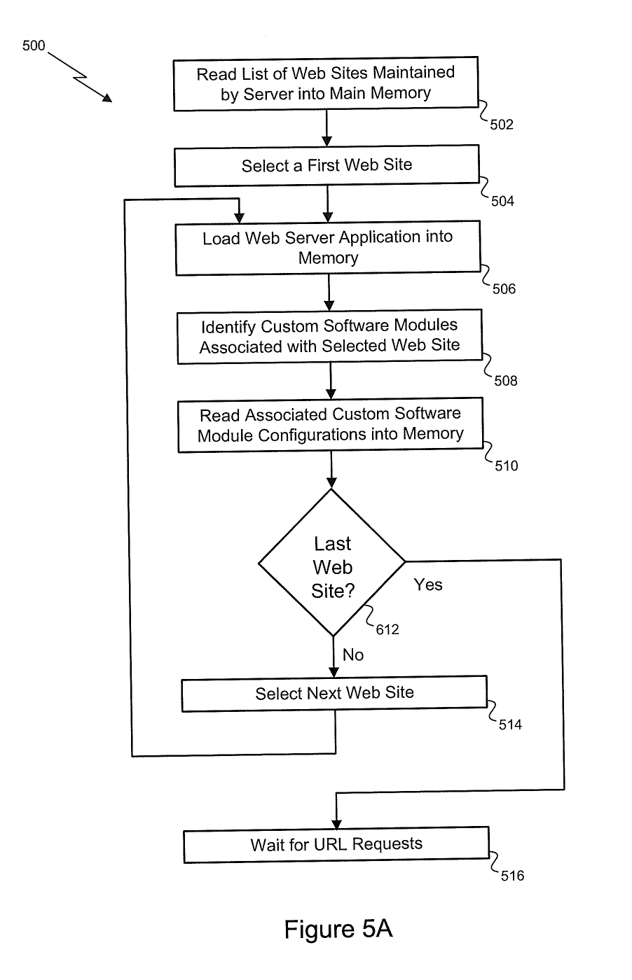

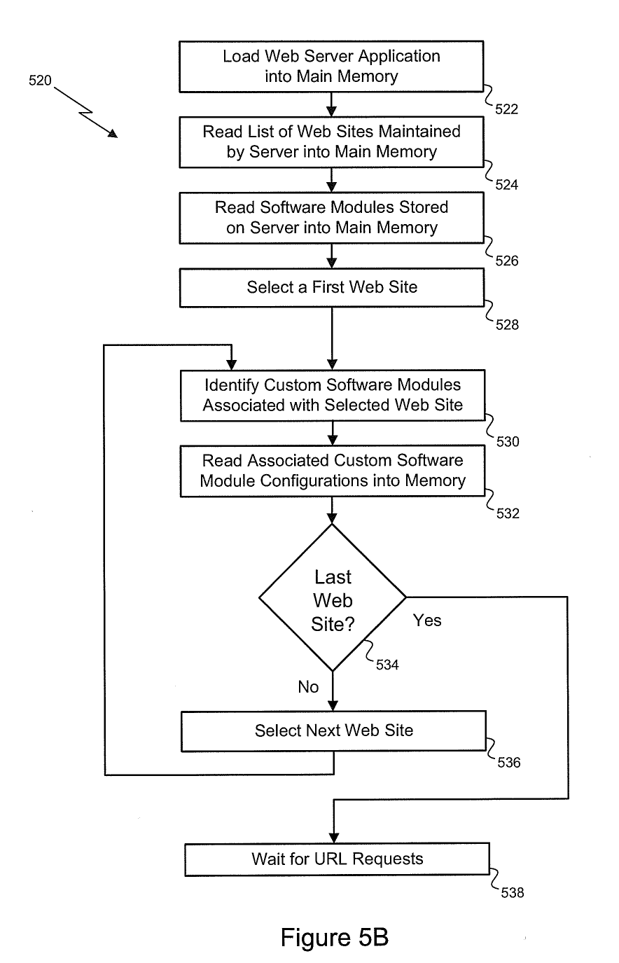

FIG. 5A shows a flowchart illustrating an exemplary method 500 that may be used to customize site configurations. In one embodiment, one or more of these method steps may invoke application server(s) 265 associated with web server application(s) 226. In other embodiments, one or more of these method steps may be performed by other software in system 200. Method 500 begins in step 502 by reading a list of web sites being brought up by server 202 from database 204. In step 504, a first web site being brought up may be selected.

In step 506, web server application(s) 226 corresponding to the selected web site may be loaded into memory 220. In one embodiment consistent with this method, each web server application 226 loaded into memory 220 can maintain a single web site on server 202. In step 508, associations between the selected web site and software modules are read into memory 220. In one embodiment, these associations may be read from database 204. In step 510, each associated software module is loaded into memory 220 for execution by the web server application corresponding to the selected web site.

In step 512, a determination is made whether the selected web site is the last web site among the list of web sites maintained by server 202, as read in step 502. If the selected web site is not the last web site maintained by server 202, method 500 continues to step 514. Otherwise, method 500 continues to step 516, where method 500 concludes by waiting for Uniform Resource Locator (“URL”) requests for web sites maintained by server 202.

In step 514, a next web site is selected from among the web sites read in step 502. Thereafter, method 500 returns to step 506.

FIG. 5B shows a flowchart illustrating another exemplary method 520 that may be used by a web server to customize site configurations. In one embodiment, these method steps may be performed by an application invoked by application server(s) 265 associated with web server application(s) 224 for a plurality of web sites. In other embodiments, one or more of these method steps may be performed by other software in system 200.

Method 520 can begin in step 522, where web server application(s) 226 can be loaded into memory 202. In one embodiment consistent with this method, a single web server application 226 loaded into memory 220 may maintain a plurality of web sites on server 202. In step 524, a list of web sites being brought up by server 202 may be read from database 204. In step 526, modules associated with web-server application(s) 226, including custom software modules 228, can be loaded into memory. In step 528, a first web site to be brought up may be selected.

In step 530, associations between the selected web site and software modules are read into memory 220. In one embodiment, these associations may be read from database 204. In step 532, each associated software module is loaded into memory 220 for execution by the web server application 226.

In step 534, a determination is made whether the selected web site is the last web site among the list of web sites maintained by server 202, as read in step 524. If the selected web site is not the last web site (“No” in step 534) maintained by server 202, the algorithm selects the next web site in step 536 and returns to step 530 to begin another iteration. Otherwise (“Yes” in step 534), the algorithm continues to step 538, where it may wait for Uniform Resource Locator (“URL”) requests to web sites served by web server application(s) 226.

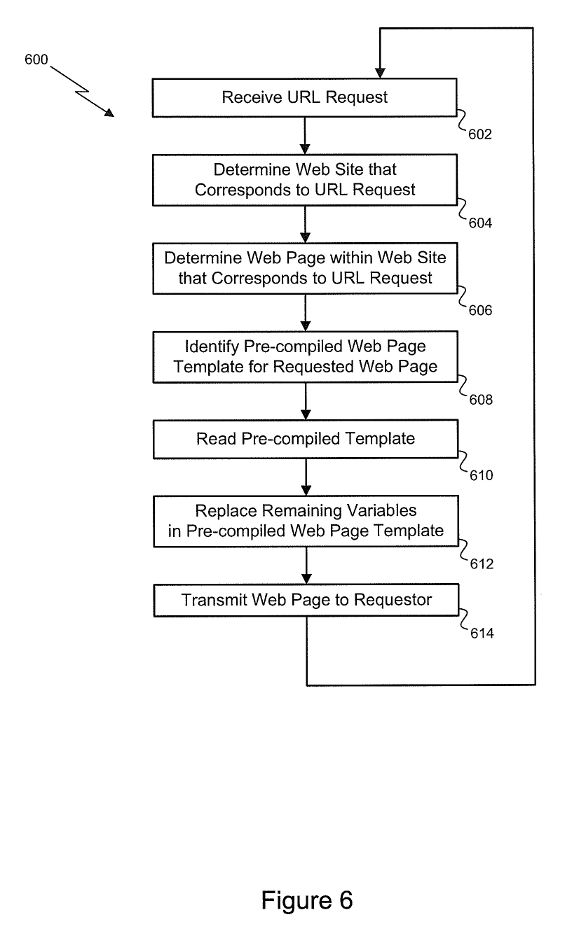

FIG. 6 shows a flowchart illustrating an exemplary method 600 for responding to URL requests directed to a web server. In one embodiment, these method steps may be performed by web server application 226. In other embodiments, one or more of these method steps may be performed by other software in system 200. Method 600 begins by receiving a URL request in step 602. This URL request may include a string reflecting the web site and web page within that web site that was requested. The URL request may also include the IP address of the system requesting the URL. Since methods for receiving a URL request, as well as identifying the web page, web site, and IP address within a URL request are commonly known by those skilled in the art, these methods are not discussed further herein. In step 604, the web site corresponding to the URL request is determined (e.g., www.site1.com). In step 606, the web page that was requested within the URL requested in step 602 is identified.

In step 608, method 600 continues the process of generating a publicly viewable web page by proceeding to generate the requested web page. In this step, the pre-compiled web page template that corresponds to the requested web page is identified. An association between a web page and its corresponding pre-compiled web page template may have been established when the web page was created. In one embodiment, this association may have been stored in database 204. In step 610, the pre-compiled web page template identified in step 608 is read. In step 612, any unprocessed variables present in the pre-compiled web page template may be replaced with their corresponding values. In one embodiment, replacing the variables with their corresponding values may involve reading their values from tables associated with the web site in database 204. In another embodiment, replacing the variables with their corresponding values may involve reading content from main memory, subsequent to the content being read from database 204 into memory during initialization of web server application 226. In step 614, the web page generated through the replacement process is communicated to the requestor. Thereafter, method 600 continues by waiting for a new URL in step 602.

Other embodiments of the present invention will be apparent to those skilled in the art from consideration of the specification and practice of one or more embodiments of the invention disclosed herein. It is intended that the specification and examples be considered as exemplary only, with a true scope and spirit of the invention being indicated by the following claims.

What is claimed is:

1. A computer-implemented method for customizably configuring the operation of a plurality of common interest community web sites using a common software platform, wherein the software platform comprises a plurality of custom functional modules, which allow customization of the web sites, method comprising:
associating at least one of the plurality of web-sites with at least one of the plurality of custom functional modules,
associating the at least one web site with a portion of the content in a database;
associating the at least one web site with at least one pre-compiled web page template, wherein the pre-compiled web page template determines, at least in part, the organization and layout of content of the associated web-site;
storing the association between the web-site and the at least one custom functional module, the association between the web-site and the content, and the association between the web-site and the at least one pre-compiled web page template in the database; and
invoking at least one web server for the at least one web site, wherein the web-server invokes the at least one custom functional module associated with the web-site and wherein, in response to a request, the web server composes a web page using the pre-compiled web page template.

2. The method of claim 1, the step of composing a web-page using the pre-compiled web further comprises:
identifying at least one of a plurality of unprocessed variables in the pre-compiled web page template,
obtaining content associated with the unprocessed variable, and
replacing the unprocessed variable with the associated content.

3. The method of claim 1, the step of invoking the at least one web server for the at least one web site further comprises invoking a single web server application for the at least one web site.

4. The method of claim 1, the step of invoking the at least one web server for the at least one web site further comprising invoking a separate instance of the web server application for each of the at least one web sites.

5. The method of claim 4, the step of invoking the at least one web server for the at least one web site further comprising invoking a separate web server application for each web site in the at least one web sites.

6. The method of claim 5, wherein the separate web server applications are child processes of a master web server.

7. The method of claim 1, wherein the pre-compiled template is generated by replacing at least one variable in a web page template with content associated with the at least one variable.

8. The method of claim 7, wherein replacing at least one variable in a web page template with content associated with the at least one variable further comprises:
receiving a selection identifying at least one of the variables for pre-compilation;
querying the database for the content associated with the at least one selected variables; and
replacing the at least one selected variable with its associated content.

9. A computer-readable medium containing instructions for controlling a server to perform a method for customizably configuring the operation of a plurality of common interest community web sites using a common software platform, wherein the software platform comprises a plurality of custom functional modules, which allow customization of the web sites, the method comprising:
associating at least one of the plurality of web-sites with at least one of the plurality of custom functional modules,
associating the at least one web site with a portion of the content in a database;
associating the at least one web site with at least one pre-compiled web page template, wherein the pre-compiled web page template determines, at least in part, the organization and layout of content of the associated web-site;
storing the association between the web-site and the at least one custom functional module, the association between the web-site and the content, and the association between the web-site and the at least one pre-compiled web page template in the database; and
invoking at least one web server for the at least one web site, wherein the web-server invokes the at least one custom functional module associated with the web-site and wherein, in response to a request from a user, the web server composes a web page using the pre-compiled web page template.

10. The computer-readable medium of claim 9, the step of composing a web-page using the pre-compiled web further comprises:
identifying at least one of a plurality of unprocessed variables in the pre-compiled web page template,
obtaining content associated with the unprocessed variable, and
replacing the unprocessed variable with the associated content.

11. The computer-readable medium of claim 9, the step of invoking the at least one web server for the at least one web site further comprises invoking a single web server application for the at least one web site.

12. The computer-readable medium of claim 9, the step of invoking the at least one web server for the at least one web site further comprising invoking a separate instance of the web server application for each of the at least one web sites.

13. The computer-readable medium of claim 12, the step of invoking the at least one web server for the at least one web site further comprising invoking a separate web server application for each web site in the at least one web sites.

14. The computer-readable medium of claim 13, wherein the separate web server applications are child processes of a master web server.

15. The computer-readable medium of claim 9, wherein the pre-compiled template is generated by replacing at least one variable in a web page template with content associated with the at least one variable.

16. The computer-readable medium of claim 15, wherein replacing at least one variable in a web page template with content associated with the at least one variable further comprises:
receiving a selection identifying at least one of the variables for pre-compilation;
querying the database for the content associated with the at least one selected variables; and
replacing the at least one selected variable with its associated content.

17. A computer-readable memory containing instructions for controlling a server to perform a method for customizably configuring the operation of a plurality of common interest community web sites using a common software platform, wherein the software platform comprises a plurality of custom functional modules, which allow customization of the web sites, the method comprising:
associating at least one of the plurality of web-sites with at least one of the plurality of custom functional modules,
associating the at least one web site with a portion of the content in a database;
associating the at least one web site with at least one pre-compiled web page template, wherein the pre-compiled web page template determines, at least in part, the organization and layout of content of the associated web-site;
storing the association between the web-site and the at least one custom functional module, the association between the web-site and the content, and the association between the web-site and the at least one pre-compiled web page template in the database; and
invoking at least one web server for the at least one web site, wherein the web-server invokes the at least one custom functional module associated with the web-site and wherein, in response to a request from a user, the web server composes a web page using the pre-compiled web page template.

18. The computer-readable memory of claim 17, the step of composing a web-page using the pre-compiled web further comprises:
identifying at least one of a plurality of unprocessed variables in the pre-compiled web page template,
obtaining content associated with the unprocessed variable, and
replacing the unprocessed variable with the associated content.

19. The computer-readable memory of claim 17, the step of invoking the at least one web server for the at least one web site further comprises invoking a single web server application for the at least one web site.

20. The computer-readable memory of claim 17, the step of invoking the at least one web server for the at least one web site further comprising invoking a separate instance of the web server application for each of the at least one web sites.
